(19) United States
(12) Patent Application Publication
(10) Pub. No.: US 2026/0309041 A1
(43) Pub. Date: Oct. 8, 2026

(54) Turbine Engine Rotor Seal and Installation Method

(71) Applicant: RTX Corporation, Farmington, CT (US)

(72) Inventors: Philip Andrew Varney, Coventry, CT (US); Richard A. Lomenzo, Jr., Enfield, CT (US)

(21) Appl. No.: 19/170,671

(22) Filed: Apr. 4, 2025

(51) Int. Cl. F01D 11/00

(52) U.S. Cl. CPC F01D 11/003; F05D 2240/55; F05D 2260/98

(57) ABSTRACT

A turbine engine rotor has a central longitudinal axis and includes: a central shaft having an outer diameter seal groove; a disk stack having a number of disks encircling the shaft; and a seal captured in the groove and facing or engaging an inner diameter surface of one of the disks. The seal is wound about the central longitudinal axis for at least 400°.

### BACKGROUND

The disclosure relates to gas turbine engines. More particularly, the disclosure relates to disk-to-shaft sealing in center-tie rotors.

Gas turbine engines (used in propulsion and power applications and broadly inclusive of turbojets, turboprops, turbofans, turboshafts, industrial gas turbines, and the like) often feature center-tie rotors wherein a shaft passes centrally through a rotor disk stack with engagement between the shaft and stack such that the shaft is held in tension and the stack is held in compression.

Operational stresses (including thermal stresses and load stresses) may cause excursions between disks and shaft. Accordingly, there often are seals between disk and shaft. In an example high pressure compressor (HPC) rotor in a multi-spool engine an example sealing system involves a piston seal ring (PSR) held in an outer diameter groove in the shaft and interfacing with an inner diameter (ID) surface of a disk bore. The seal may isolate an inter-disk space aft thereof that's used to pass air radially inward to then pass aft a to the turbine section for turbine cooling. Additionally, a diverted airflow may pass radially through holes in the shaft from forward of the seal to pass forward and/or aft within the shaft to provide bearing cooling. Nevertheless, leakage through the joint of the PSR remains a problem. Typical such piston seal rings are split rings with a single shiplap joint.

In a separate art, spiral lock rings are known. Examples are sold by Smalley Steel Ring Company of Lake Zurich, Illinois under the trademark SPIROLOX®. Examples of such rings have circumferential extents of just under 720°. This allows the ring to be formed as a spiral with a central jog or kink allowing terminal portions to inter-nest. Thus, the terminal portions approach the kink from opposite circumferential directions and nearly meet but do not meet. Thus, the lock ring has an example circumferential extent of about 700°.

### SUMMARY

One aspect of the disclosure involves a turbine engine rotor having a central longitudinal axis and comprising: a central shaft having an outer diameter seal groove; a disk stack having a plurality of disks encircling the shaft; and a seal captured in the groove and facing or engaging an inner diameter surface of one of the disks. The seal is wound about the central longitudinal axis for at least 400°.

In a further embodiment of any of the foregoing embodiments, additionally and/or alternatively the shaft has a slot intersecting the seal groove with circumferential and axial directional components.

In a further embodiment of any of the foregoing embodiments, additionally and/or alternatively, the slot has a median helix angle of 60° to 85°.

In a further embodiment of any of the foregoing embodiments, additionally and/or alternatively, the shaft has at most two said slots intersecting the seal groove.

In a further embodiment of any of the foregoing embodiments, additionally and/or alternatively, the shaft has only a single said slot intersecting the seal groove.

In a further embodiment of any of the foregoing embodiments, additionally and/or alternatively, the shaft has a plurality of holes forward of the seal groove.

In a further embodiment of any of the foregoing embodiments, additionally and/or alternatively, the central shaft has a radial ridge having a first axial end face at least partially forming a sidewall of the groove.

In a further embodiment of any of the foregoing embodiments, additionally and/or alternatively, In a further embodiment of any of the foregoing embodiments, additionally and/or alternatively, along a majority of the circumferential length of the seal, the seal has a rectangular turn cross-section.

In a further embodiment of any of the foregoing embodiments, additionally and/or alternatively, the seal has a turn cross-section that tapers in thickness toward circumferential ends. The tapering may be over an angular span θ_{T} of an example at least 15°, more particularly at least 30° or 15° to 360° or 15° to 345° with alternative lower limits of 30°. An example number of turns at full thickness T_{M} is at least one turn (360°), more broadly, 0° to 1080° or 0° to 720° or, more narrowly, 360° to 1080° or 360° to 720°.

In a further embodiment of any of the foregoing embodiments, additionally and/or alternatively, the seal comprises a lubricious coating on a metallic substrate.

In a further embodiment of any of the foregoing embodiments, additionally and/or alternatively, the seal comprises an MoS₂ coating.

In a further embodiment of any of the foregoing embodiments, additionally and/or alternatively, the seal is wound about the central longitudinal axis for 680° to 1200°.

In a further embodiment of any of the foregoing embodiments, additionally and/or alternatively, the seal is not in axial compression contact with first and second sidewalls of the groove.

In a further embodiment of any of the foregoing embodiments, additionally and/or alternatively, the seal is not axially expanded.

A further embodiment of any of the foregoing embodiments may additionally and/or alternatively include a turbine engine including the turbine engine rotor.

A further aspect of the disclosure involves a method for manufacturing the turbine engine rotor. The method comprises: installing the seal to the groove by passing the seal through a slot open to a sidewall of the groove; and installing the disk stack to the shaft

A further aspect of the disclosure involves a method for using the turbine engine rotor. The method comprises: rotating the rotor about a central axis; and the rotating causing a radial expansion of the seal to cause engagement with said inner diameter surface of one of the disks or increase an engagement pressure therewith.

A further aspect of the disclosure involves a seal comprising: a coiled metallic substrate having multiple turns of a rectangular cross-section, said rectangular cross-section having first and second axial faces, an inner diameter face, and an outer diameter face; and a solid lubricant on the outer diameter face and the first and second axial faces.

In a further embodiment of any of the foregoing embodiments, additionally and/or alternatively, one or more of: the solid lubricant comprises MoS₂, optionally at least 50% MoS₂; by weight; the seal has a turn cross-section of radial span at least 300% of thickness over at least 75% of a circumferential extent of the seal; the seal has a turn cross-section that tapers in thickness toward circumferential ends, optionally tapering from a maximum thickness by at least 30% total and at least 10% over a span of at least 30°; and the substrate is nickel-based alloy or cobalt-based alloy.

A further aspect of the disclosure involves a method for assembling a turbine engine rotor, the turbine engine rotor having a central longitudinal axis and comprising: a central shaft having an outer diameter seal groove; a disk stack having a plurality of disks encircling the shaft; and a seal captured in the groove and facing or engaging an inner diameter surface of one of the disks. The method comprises threading the seal into the groove through a slot open to an axial end wall surface of the groove.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a half sectional view of a high pressure compressor (HPC) rotor.

FIG. 1A is an enlarged view of a seal region of the rotor of FIG. 1.

FIG. 1B is a further enlarged view of the seal region of the rotor of FIG. 1.

FIG. 1C is a further enlarged view of the seal region of the rotor of FIG. 1.

FIG. 2 is an outer diameter (OD) view of a shaft of the rotor having a seal in a groove.

FIG. 3 is a sectional view of the seal of FIG. 2.

FIG. 3A is an enlarged view of the seal.

FIG. 4 is an outer diameter (OD) view of the shaft of the rotor during seal installation.

FIG. 5 is a schematic half section of a turbofan engine.

Like reference numbers and designations in the various drawings indicate like elements.

### DETAILED DESCRIPTION

In the example reconfiguration of a baseline gas turbine engine, the shiplap piston seal ring is replaced with a spiral ring seal. Such a ring may, in some embodiments resemble a spiral lock ring. To install the spiral ring, a slot is provided in a shoulder or flange of the shaft axially open at a first axial end at the slot and a second axial end away from the slot. The slot has a tangential component allowing the seal ring to be threaded/wound through the slot into the groove.

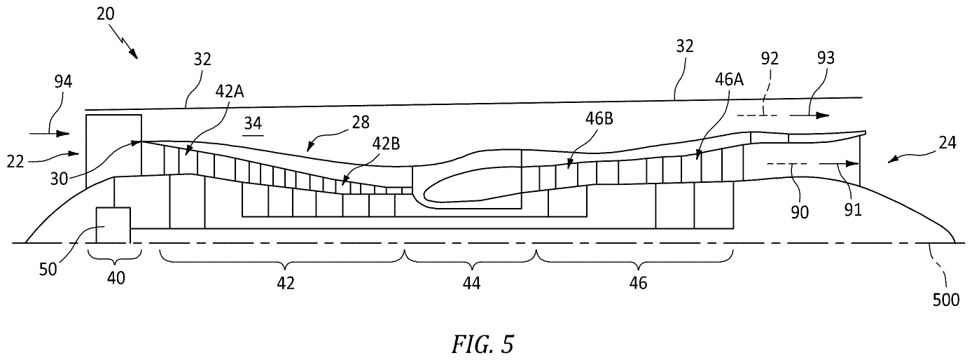

FIG. 5 shows a gas turbine engine 20. As is discussed below, the engine is illustrated as a schematic modification of a baseline existing engine. FIG. 5 schematically shows the example gas turbine engine 20 as a turbofan engine having a centerline or central longitudinal axis 500 and extending from an upstream end at an inlet 22 to a downstream end at an outlet 24. The example engine schematically includes a core flowpath or gaspath 90 passing a core flow 91 and a bypass flowpath 92 passing a bypass flow 93. The core flow and bypass flow are initially formed by respective portions of a combined inlet airflow 94 divided at a splitter 30. Thus, the example core flow starts out as air and downstream of the combustor comprises combustion products as combustion gas.

A core case (inner diameter (ID) case) or other structure 28 divides the core flowpath from the bypass flowpath. The bypass flowpath is, in turn, surrounded by an outer case (outer diameter (OD) case) 32 which, depending upon implementation, may be a fan case. A bypass duct 34 is configured radially between the ID case and OD case. From upstream to downstream, the engine includes a fan section 40 having one or more fan blade stages, a compressor 42 having one or more sections 42A, 42B each having one or more blade stages, a combustor 44 (e.g., annular, can type, or reverse flow), and a turbine 46 again having one or more sections 46A, 46B each having one or more blade stages. For example, many so called two-spool engines have two compressor sections (low pressure 42A and high pressure 42B) and two turbine sections (high pressure 46B and low pressure 46A) with each turbine section driving a respective associated compressor section and the low pressure downstream turbine section 46A also driving the fan (optionally via a gear reduction 50). Yet other arrangements are possible.

Various illustrated and non-illustrated features of the engine may be otherwise conventional including basic control hardware, programming, and use and manufacture methods.

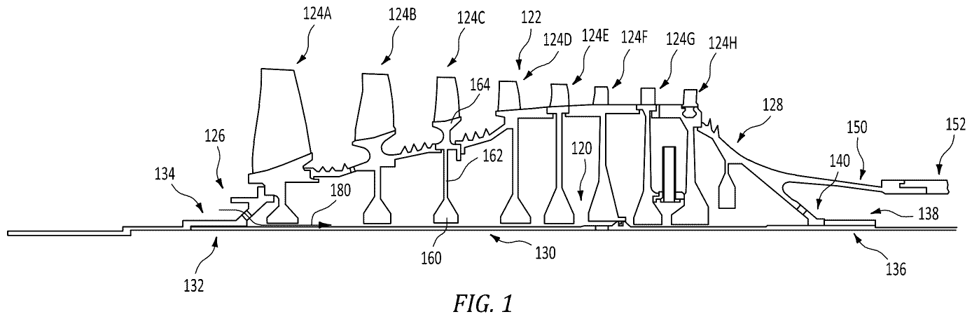

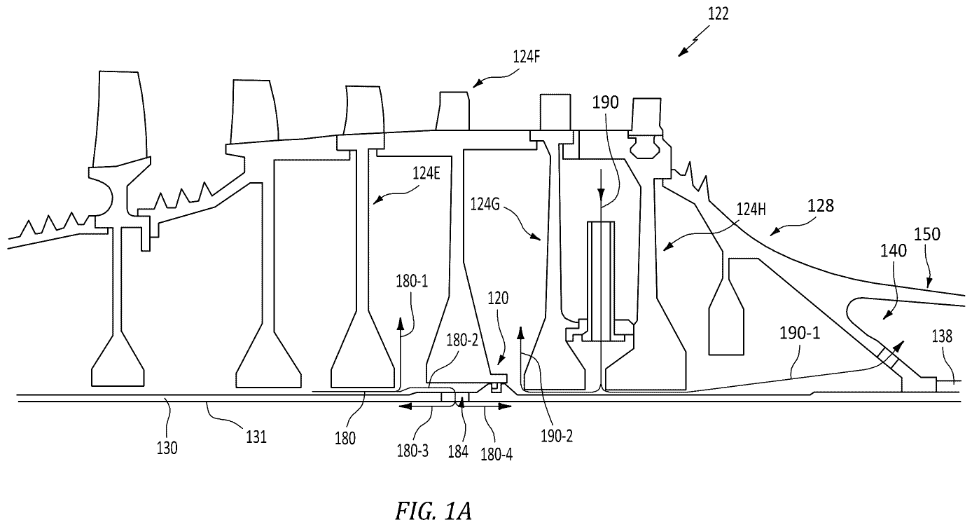

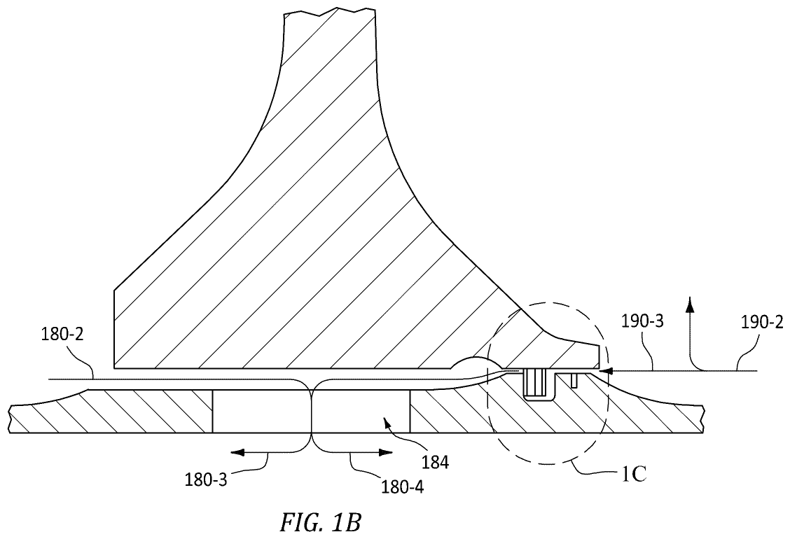

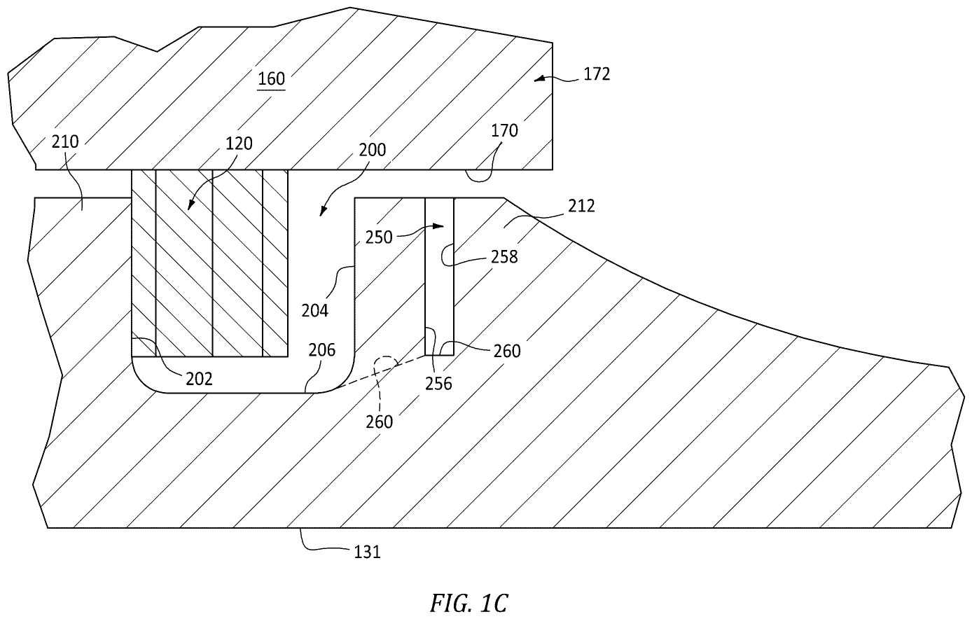

FIG. 1A shows a seal 120 in the HPC rotor 122. The example rotor comprises a stack of disks 124A-124H. In this particular example, disks 124A-124G are known as “integrally-bladed rotors” (IBR) or “bladed disks” (blisks); whereas, the disk 124H has a circumferential array of blades mounted at the outer rim of the disk. The various disks have spacers extending fore or aft to mate with adjacent disks. FIG. 1 shows some of these spacers having radially inwardly open/facing distal shoulder surfaces receiving shoulders of the adjacent disk whereas others have radially outwardly open/facing shoulder surfaces. For example, the disk 124B has a forward spacer with a radially inwardly open shoulder and a rearward spacer with a radially outwardly open shoulder. Some of the spacers have radially outwardly protruding knife edges for cooperating with abradable material at inboard/inner platforms or shrouds of vane stages to create respective knife edge sealing systems.

The disk stack is held in axial compression between a forward hub 126 and an aft or rearward hub 128 to form a rotor stack. The term “rotor” is often interchangeably used to identify anything from a single disk (e.g., as in IBR noted above), expanding in scope to the disk stack (without hubs or shaft), then further to the extent of including the hubs and the shaft but only within a given section (e.g., treating the HPC and HPT rotor sections as distinct rotors), and up to an entire structure that rotates as a unit (which would include the HPC rotor, the HPT rotor, and the shaft all as a high speed rotor).

The example fore and aft hubs each have distal radially outwardly open shoulders mating with the adjacent disk. A tension shaft 130 holds the rotor under compression while the adjacent portion of the shaft is under tension. The example shaft 130 has an externally threaded forward end section 132 engaged to an internally threaded compartment 134 of the forward hub to transmit axial forces. The shaft 130 also has a second externally threaded portion 136 well aft thereof receiving a nut 138. The nut 138 holds a so-called kickstand portion (or inner hub) 140 of the aft hub 128 in axial compression to complete the compressive force transmission path through the rotor. The example aft hub 128 also has an outer hub or driving section 150 coupled to a corresponding forward portion 152 of the HPT rotor to allow the HPT rotor to drive rotation of the HPC rotor. In various embodiments, the shaft 130 may continue through to join with or become an HPT shaft. In the example shown, the hub 126 forward of the junction between the threaded sections 132 and 134 again becomes a portion of a high spool shaft and may mate with bearings, accessory drives, and the like.

The various disks have radially inboard protuberant bores 160 connected via thinner intermediate radial webs 162 to outer rim sections 164.

FIG. 1A shows a first leakage or bleed flow 180 from relatively upstream in the compressor passing several branches shown as 180-1, 180-2, 180-3, and 180-4. Flow 180 passes between the ID surface of the bore of the disk 124E and the OD surface of the shaft 130 with 180-1 then passing radially outward between disks 124E and 124F for cooling and branch 180-2 passing through a circumferential array of apertures 184 in the shaft to then further branch into flows 180-3 and 180-4 with 180-3 then passing forward for forward bearing compartment buffering and 180-4 then passing aft for bearing compartment buffering. An additional leakage flow from yet downstream in the HPC is shown as 190. This passes radially inward between the disks 124G and 124H, then principally passing as a branch 190-1 between the bore ID surface of the disk 124H and the shaft OD surface to ultimately pass through a circumferential array of apertures in the inner hub/kickstand 140 for HPT cooling. The seal 120 isolates these flows from each other. A further branch 190-2 may pass forward between the bore ID surface of the disk 124G and the shaft OD surface to ultimately pass radially outward between the disks 124F and 124G to cool such disks. As discussed below, a further flow 190-3 (FIG. 1B) may branch off the flow 190.2 and bypass the seal 120 to merge with the flow 180-2

FIGS. 1B and 1C show an enlarged views of the seal 120 interactions with the shaft and the associated disk bore. The seal may replace a hypothetical baseline piston seal ring captured in a groove in the shaft and having an OD surface engaging an ID surface 170 of the associated disk bore (e.g., in this case, a rearwardly extending foot 172). The baseline PSR is a split ring seal. The split creates an asymmetric leakage flow 190-3 through the seal split (e.g., shiplap joint). A number of proposals attempt to compensate for this by introducing additional leakage flows to mitigate the asymmetry. However, the additional leakage flows do not fully eliminate asymmetry and may reduce process efficiency.

As noted above, the seal 120 is captured in a radially outwardly open groove 200. The groove has a forward/fore wall surface 202, an aft wall surface 204, and a radially inward base surface 206. Rounded or other transitions may exist at corners/junctions between the base and the fore and aft wall surfaces. The example groove is formed in a radially protruding structure so as to not compromise wall thickness between the base 206 and shaft inner diameter (ID) surface 131. This creates fore and aft protruding shoulders or flanges 210 and 212.

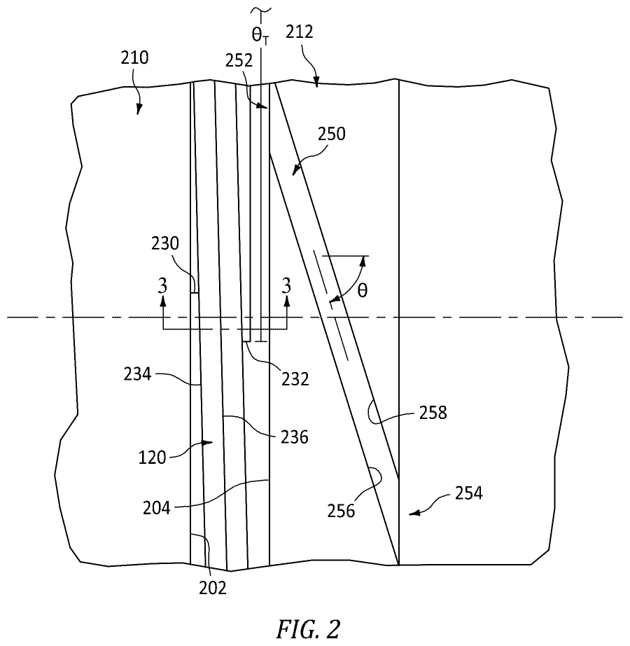

The seal 120 is formed as a spiral strip extending from a first circumferential end 230 to a second circumferential end 232 (FIG. 2). The strip has a generally rectangular cross-section with a first generally axially-facing face 234 and an opposite second generally axially-facing face 236 and an inner diameter face 238 and an outer diameter face 240. Thus, the forward face of the seal is formed by the strip face 234 along the forwardmost turn of the seal. The aft face of the seal is formed by the strip face 236 along the aftmost turn of the seal. The inner diameter (ID) face of the seal is formed by the strip ID face 238 along the combined turns of the seal. The outer diameter (OD) face of the seal is formed by the strip OD face 240 along the combined turns of the seal.

As noted above, a seal installation slot 250 (FIG. 2) is radially outwardly open and extends through the shoulder/flange 212 from a forward/fore open end (opening) 252 along the groove aft wall to a rear/aft open end 254 along an aft face of the shoulder/flange 212. The slot (FIG. 1C) has lateral surfaces 256 and 258 and a base surface 260. The base surface may diverge radially from the forward opening 252 to the aft opening 254.

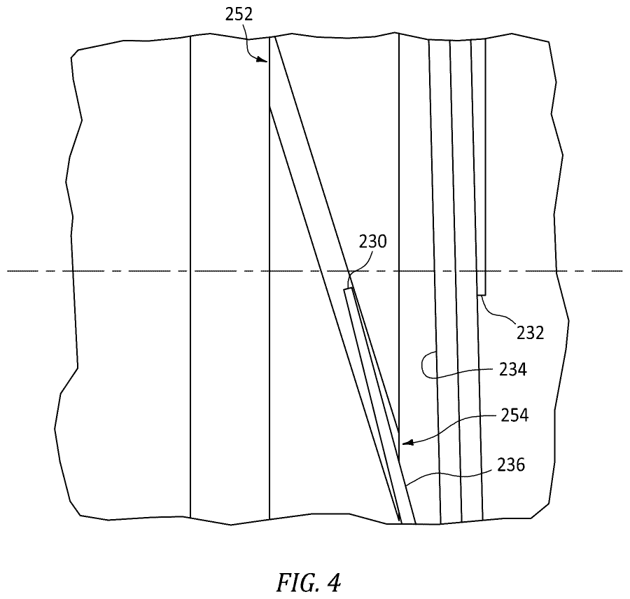

FIG. 2 shows the slot off-axial by a helix angle θ discussed below. The angling allows the seal to be threaded into the slot (FIG. 4). This may be done with the relevant interfacing disk already assembled to the shaft or before. A worker may slide the seal over the shaft to the aft shoulder/flange 212 and then manually pry open the seal adjacent the end 230 so that locally a separation opens between the face 236 near the end 230 and the adjacent face 234 along the next turn of the seal. This allows the end 230 to be inserted into the slot aft opening 254. Thereafter, the worker may continue to rotate the seal relative to the shaft to thread the seal into the slot. Eventually the end 232 is in the slot and the worker may use a tool (e.g., a non-metallic pusher (to avoid scratching)) to press the end 232 further into the slot until the end finally snaps into the groove. In some examples, the seal may be dimensioned so that in a static condition there is light contact between the seal OD surface and the borefoot 272 ID surface 170 essentially full circumference. Or there may be a slight centered static gap (in some examples of which situation the seal may be in full circumferential contact with the groove base). Upon engine startup, centrifugal action will radially expand and correspondingly circumferentially unwind the seal to close any radial gap with the borefoot (while creating or expanding a centered radial gap with the groove base) and then cause firmer radial sealing engagement. Pressure difference across the seal will bias the forward seal face into contact with the groove forward face 202.

In some embodiments, the seal 120 may be formed similarly to a spiral lock ring with a central circumferential kink/jog (not shown) and a total circumferential extent (between ends 230 and 232) of just under 720° with the ends falling just short of the kink/jog. However, the example seal is more of a true spiral lacking the kink/jog. The axial thickness of the strip forming the seal may taper toward its circumferential ends so as to present a smoother interface with the groove sidewall. This may result in less stress concentration for longer wear life and better sealing than a non-tapering configuration.

The circumferential extent of either a kinked/jogged spiral or a more true spiral may be at least an example 400°. Advantageously, however, this may be higher. The kinked/jogged seal may advantageously be in a range of about 680° to about 710°. The more pure spiral may yet increase beyond that with key examples of up to about three turns/revolutions. An exact three-turn example would thus be 1080°. Thus, one range is 680° to 1200° to cover both the likely range of kinked/jogged seals and a likely lower end range of more true spiral seals. A yet narrower range is 680° to 1060°.

Even non-tapering seals may have their edges taken down at the circumferential ends to round the ends to avoid sharp edges. The tapering seals may taper over an angular span θ_{T} of an example at least 15°, more particularly at least 30° or 15° to 360° or 15° to 345° with alternative lower limits of 30°.

The example shaft has just a single such slot. In some implementations, for balance or symmetric thermal behavior, it may be advantageous to have a second diametrically opposed slot even though only one is necessary for seal installation and removal. This may distinguish slots or holes used for venting or cooling purposes which may have a much greater count.

The example slot is relatively shallow in terms of helix angle θ to be much closer to circumferential than to axial. This allows the threading into the slot. An example helix angle is thus 60° to 85° measured as the centerline of the slot off the axial direction. This may be a median value or a modal value or a mean value. In the example pure helical slot, these are all the same. However, other slot planforms are possible. The lower end of this range may be more difficult to install the ring to the groove. The higher end may: be more difficult to manufacture the slot; thin down walls adjacent to the slot; and due to material removal more greatly imbalance the shaft.

The sense of the slot (e.g., such as a righthanded thread versus a lefthanded thread) may be selected so that the maximum anticipated angular acceleration magnitude of the engine will not drive the ring back into the slot. Thus, the rotation direction may advantageously be in the opposite direction of the circumferential component of the slot from outside the groove to inside the groove if such maximum is on a startup or acceleration of the engine. If the maximum is on a stopping or deceleration, then sense would be reversed.

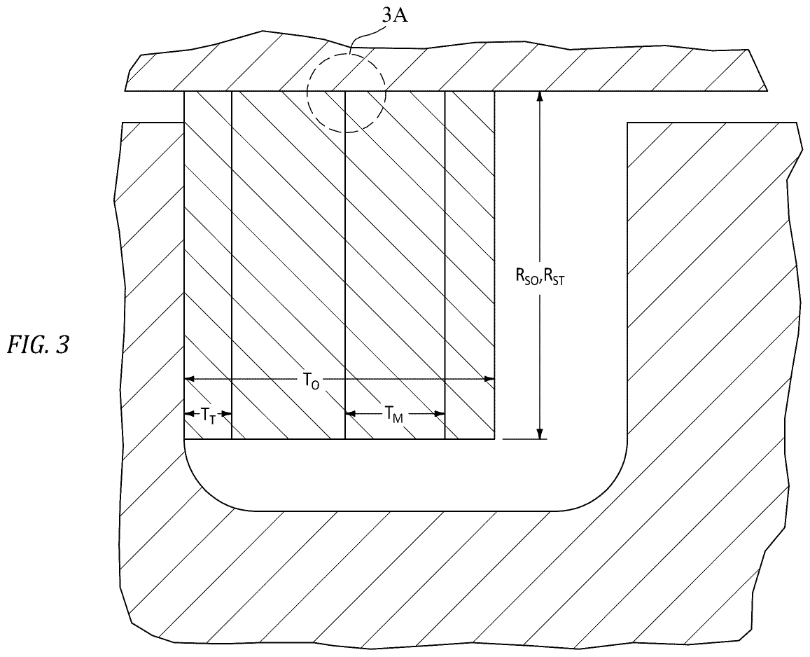

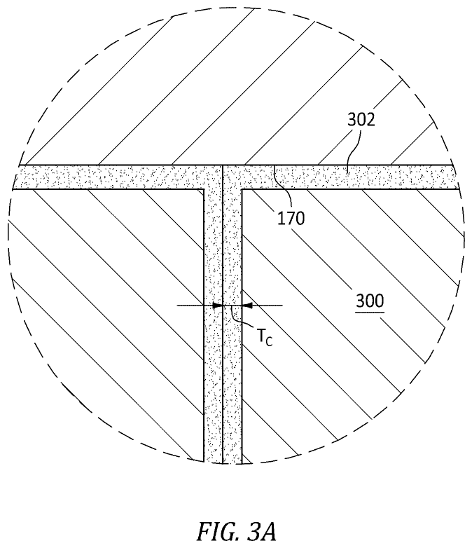

The example seal has an overall cross-section radial span R_{SO} (FIG. 3) and an overall cross-sectional thickness T_{O}. Additionally, each turn circumferential location has its own radial span R_{ST} (which may be the same as R_{SO}) and thickness T_{T} at a given circumferential position Which reaches a maximum value of T_{M} away from the taper. Away from the taper (or at the thickest portion in a situation of continuous taper) the aspect ratio of the turn radial span R_{ST} to axial thickness T_{M} may be about 3:1, more broadly, 2:1 to 4:1 or 2.5:1 to 5.0:1. The taper may be such that T_{T} tapers from T_{M} by at least 30% total and at least 10% over a span of at least 30° (i.e., T_{T}≤T_{M} over at least a span of 30° at each end). Alternatively, these values may reflect the overall cross-section of the seal and the number of turns. An example number of turns at full thickness T_{M} is at least one turn (360°), more broadly, 0° to 1080° or 0° to 720° or, more narrowly, 360° to 1080° or 360° to 720°. The overall cross-section may be close to square (i.e., R_{SO} and R_{ST} are about equal to T_{O}). More broadly, such radial span R_{SO} and R_{ST} may be about 75% to 150% of T_{O}.

The example seal comprises a metallic substrate 300 optionally coated 302 (FIG. 3A showing coating thickness T_{C}). The example substrate material is nickel-based alloy or cobalt-based alloy. Depending upon the implementation, there may be hard coatings and/or lubricious coatings with various physical distributions. In one example implementation, there is a lubricious coating (e.g., MoS₂) upon the outer diameter surface. In another, the lubricious coating (e.g., MoS₂) may be on the faces 234, 236, and 240. In another, the lubricious coating (e.g., MoS₂) may be on the faces 234, 236, 238, and 240.

The substrate strip that forms the spiral thus also extends from a first circumferential end to a second circumferential end, has a first generally axial face and a second generally axial face, an inner diameter (ID) face, and an outer diameter (OD) face. The resulting generally rectangular cross-section leaves respective edges between the axial faces and adjacent ID and OD faces.

Component materials and manufacture techniques and assembly techniques may be otherwise conventional.

The use of “first”, “second”, and the like in the following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

One or more embodiments have been described. Nevertheless, it will be understood that various modifications may be made. For example, when applied to an existing baseline configuration, details of such baseline may influence details of particular implementations. Accordingly, other embodiments are within the scope of the following claims.

What is claimed is:

1. A turbine engine rotor having a central longitudinal axis and comprising:
a central shaft having an outer diameter seal groove;
a disk stack having a plurality of disks encircling the shaft; and
a seal captured in the groove and facing or engaging an inner diameter surface of one of the disks,
wherein:
the seal is wound about the central longitudinal axis for at least 400°.

2. The turbine engine rotor of claim 1 wherein:
the shaft has a slot intersecting the seal groove with circumferential and axial directional components.

3. The turbine engine rotor of claim 2 wherein:
the slot has a median helix angle of 60° to 85°.

4. The turbine engine rotor of claim 2 wherein:
the shaft has at most two said slots intersecting the seal groove.

5. The turbine engine rotor of claim 2 wherein:
the shaft has only a single said slot intersecting the seal groove.

6. The turbine engine rotor of claim 1 wherein:
the shaft has a plurality of holes forward of the seal groove.

7. The turbine engine rotor of claim 1 wherein the shaft has a radial ridge having:
a first axial end face at least partially forming a sidewall of the groove.

8. The turbine engine rotor of claim 1 wherein along a majority of the circumferential length of the seal, the seal has a rectangular turn cross-section.

9. The turbine engine rotor of claim 1 wherein the seal has a turn cross-section that tapers in thickness toward circumferential ends.

10. The turbine engine rotor of claim 1 wherein:
the seal comprises a lubricious coating on a metallic substrate.

11. The turbine engine rotor of claim 1 wherein:
the seal comprises an MoS₂ coating.

12. The turbine engine rotor of claim 1 wherein:
the seal is wound about the central longitudinal axis for 680° to 1200°.

13. The turbine engine rotor of claim 1 wherein:
the seal is not in axial compression contact with first and second sidewalls of the groove.

14. The turbine engine rotor of claim 1 wherein:
the seal is not axially expanded.

15. A turbine engine including the turbine engine rotor of claim 1.

16. A method for manufacturing the turbine engine rotor of claim 1, the method comprising:
installing the seal to the groove by passing the seal through a slot open to a sidewall of the groove; and
installing the disk stack to the shaft.

17. A method for using the turbine engine rotor of claim 1, the method comprising:
rotating the rotor about a central axis; and
the rotating causing a radial expansion of the seal to cause engagement with said inner diameter surface of one of the disks or increase an engagement pressure therewith.

18. A seal comprising:
a coiled metallic substrate having:
multiple turns of a rectangular cross-section, said rectangular cross-section having first and second axial faces, an inner diameter face, and an outer diameter face; and
a solid lubricant on the outer diameter face and the first and second axial faces.

19. The seal of claim 18 wherein one or more of:
the solid lubricant comprises MoS₂, optionally at least 50% MoS₂; by weight;
the seal has a turn cross-section of radial span at least 300% of thickness over at least 75% of a circumferential extent of the seal;
the seal has a turn cross-section that tapers in thickness toward circumferential ends, optionally tapering from a maximum thickness by at least 30% total and at least 10% over a span of at least 30°; and
the substrate is nickel-based alloy or cobalt-based alloy.

20. A method for assembling a turbine engine rotor, the turbine engine rotor having a central longitudinal axis and comprising:
a central shaft having an outer diameter seal groove;
a disk stack having a plurality of disks encircling the shaft; and
a seal captured in the groove and facing or engaging an inner diameter surface of one of the disks,
the method comprising:
threading the seal into the groove through a slot open to an axial end wall surface of the groove.
